(19) United States
(12) Patent Application Publication
(10) Pub. No.: US 2008/0313592 A1
(43) Pub. Date: Dec. 18, 2008

(54) MASK LAYOUT EDITOR SHAPE QUERY

(75) Inventor: Richard S. Brink, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/761,485

(22) Filed: Jun. 12, 2007

(51) Int. Cl. G06F 17/50

(52) U.S. Cl. 716/11

(57) ABSTRACT

A computer program product stored on machine readable media includes machine executable instructions for display a layout of a circuit design, the product including instructions for displaying a layout of a circuit design, the product including instructions for: receiving query input including location information; querying a design layout for object information associated with the location information; and reporting the object information. A system is also provided.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to design layout editors, and particularly to features for shape query.

2. Description of the Related Art

A circuit or layout designer often uses a layout editor to edit a design for a circuit. Layouts can easily get confusing to view and it is very hard to distinguish information between sections in the entire layout. For example, it is often difficult to determine which layers within a design include features at a specific location (i.e., coordinate).

What are needed are features that provide additional functionality to the layout editor. The features should enable a designer to more quickly identify components of a layout that are related to user identified coordinates. Preferably, the features provide other benefits, such as visual indications and reporting of the components.

### SUMMARY OF THE INVENTION

The shortcomings of the prior art are overcome and additional advantages are provided through the provision of a computer program product stored on machine readable media including machine executable instructions for display a layout of a circuit design, the product including instructions for displaying a layout of a circuit design, the product including instructions for: receiving query input including location information; querying a design layout for object information associated with the location information; and reporting the object information.

Also disclosed is a system for editing a layout of a circuit, the system including: processing, display, storage, input and output resources for executing machine readable instructions stored in the storage; the machine readable instructions for displaying a layout of a circuit design, and providing object information by instructions for: receiving query input including location information; querying a design layout for object information associated with the location information; and reporting the object information.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

Technically, a simpler user interface having better usability is provided. That is, as a result of the summarized invention, technically we have achieved a solution which a computer program product stored on machine readable media is provided and includes machine executable instructions for incorporation into a layout editor for layout of a circuit design, the instructions for display of the layout of the circuit design, the product including instructions for: receiving query input including location information including at least one of a location of an object, coordinates for a point and a region of points; querying a design layout for object information associated with the location information by querying at least one of each layer within the design layout and selected layers within the design layout; and reporting the object information for objects that are one of associated with a location, within a two-dimensional boundary and within a three-dimensional boundary to the layout editor for output.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an infrastructure for operation of a layout editor.

The detailed description explains the preferred embodiments of the invention, together with advantages and features, by way of example with reference to the drawings.

### DETAILED DESCRIPTION OF THE INVENTION

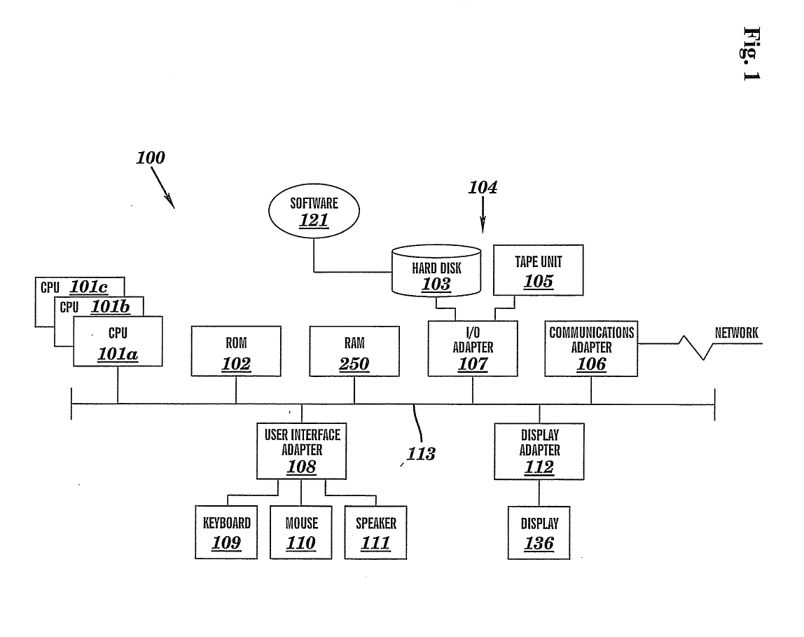

Referring to FIG. 1, there is shown an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for layout and editing of a circuit design. As referred to herein, the instructions are referred to as “design layout software” 121. The software 121 may be produced using software development tools as are known in the art. As discussed herein, the software 121 may also be referred to as a “layout editor” 121 or simply as an “editor” 121. The layout editor 121 may include various editing tools and layout features as are known in the art.

The layout editor 121 permits a designer to focus on a particular aspect of a circuit layout, or a layout of a similar nature. As used herein, these aspects are generally referred to as “coordinates” within a layout. Coordinates may be identified according to various conventions, such as by screen area, layout area, workspace area, with relation to a given point of origin and by other such schemes as are known in the art.

In some embodiments, the editor 121 provides users with object information in response to query input information. In some embodiments, object information is determined by performing a query for a given location. For example, by initiating a query (such as by a keyboard command, a right click, use of a pulldown menu, or by other similar techniques) and by using a pointing device (such as the mouse 110) the user provides query input. Query input may be provided by selecting at least one of a given set of coordinates (such as by indicating a single point, a region of points) and at least one object. In this example, and as a result to the query, the editor 121 returns all objects associated with the single point or region of points.

For example, in another embodiment, the user identifies an object. The editor 121 returns all other objects that have coordinates similar to the identified object. More specifically, consider an embodiment where clicking on a point inside a via results in a list that includes the via, the metal above and below, and other such features. In some embodiments, the editor 121 reports the object information according to layer or other similar component or classification, while in other embodiments, the editor reports the object information for all objects within the entire design layout.

In some embodiments, the software 121 provides a locating function as an overlay to another program providing for layout editing. For example, the software 121 may be provided as an “add-in” to an application (where “add-in” is taken to mean supplemental program code as is known in the art). In such embodiments, the software 121 may replace structures of the application for determining coordinates by techniques described herein.

In various embodiments, users may set a tolerance for the amount of location information to be returned by the query. For example, the user may wish to obtain object information for all objects within a distance of X incremental measurements from a specific point or object (i.e., within a two-dimensional (2D) or a three-dimensional (3D) boundary). In some embodiments, the distance is uniformly distributed about the specific point (i.e., a spherical distribution). In other embodiments, the distance may be determined according to directional coordinates, such as an X-axis, a Y-axis and a Z-axis, or by other coordinate schemes as are known in the art. One skilled in the art will recognize that such embodiments may be particularly useful for determine potential interferences, such as from the generation of electromagnetic fields.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine executable instructions for displaying a layout of a circuit design, the product comprising instructions for:
receiving query input comprising location information;
querying a design layout for object information associated with the location information; and
reporting the object information.

2. The computer program product as in claim 1, wherein the location information comprises at least one of a location of an object, coordinates for a point and a region of points.

3. The computer program product as in claim 1, wherein querying the design layout comprises querying each layer within the design layout.

4. The computer program product as in claim 1, wherein querying the design layout comprises querying selected layers within the design layout.

5. The computer program product as in claim 1, where reporting the object information comprises reporting objects that are one of associated with a location, within a two-dimensional boundary and within a three-dimensional boundary.

6. A computer program product stored on machine readable media and comprising machine executable instructions for incorporation into a layout editor for layout of a circuit design, the instructions for display of the layout of the circuit design, the product comprising instructions for:
receiving query input comprising location information comprising at least one of a location of an object, coordinates for a point and a region of points;
querying a design layout for object information associated with the location information by querying at least one of each layer within the design layout and selected layers within the design layout; and
reporting the object information for objects that are one of associated with a location, within a two-dimensional boundary and within a three-dimensional boundary to the layout editor for output.

7. A system for editing a layout of a circuit, the system comprising:
processing, display, storage, input and output resources for executing machine readable instructions stored in the storage; the machine readable instructions for displaying a layout of a circuit design, and providing object information by instructions for:
receiving query input comprising location information;
querying a design layout for object information associated with the location information; and
reporting the object information.
